(19) United States
(12) Patent Application Publication
(10) Pub. No.: US 2019/0266684 A1
(43) Pub. Date: Aug. 29, 2019

(54) System and Method for Identifying and Assigning Professionals for a Particular Task

(71) Applicant: Mplace, LLC, Annapolis, MD (US)

(72) Inventors: Caleb H. King, Park City, UT (US); Aden King, Annapolis, MD (US)

(73) Assignee: Mplace, LLC, Annapolis, MD (US)

(21) Appl. No.: 15/879,022

(22) Filed: Jan. 24, 2018

Related U.S. Application Data
(60) Provisional application No. 62/449,625, filed on Jan. 24, 2017.

(51) Int. Cl. G06Q 50/18; G06Q 10/06; G06Q 10/10

(52) U.S. Cl. CPC G06Q 50/18; G06Q 10/1053; G06Q 10/063112

(57) ABSTRACT

A system and method for identifying and assigning professionals to perform a particular task. The candidate first inputs user information, such as contact information, bar admission status, education and work experience, for example. Next, the system verifies the user information, performs a background check and determines if the candidate has a conflict with the client for a particular task. Candidates with verified user information and background checks, and no conflicts are entered into a qualified candidate pool. An administrator for the particular task can review the user information of each qualified candidate. The administrator may select to submit a placement request to a qualified candidate. The qualified candidate has a specified time period within which he or she must either accept or reject the placement request. If the qualified candidate accepts the placement request, he or she is staffed for the task.

### CROSS-REFERENCE TO RELATED APPLICATIONS

The present application claims priority to U.S. Provisional Application No. 62/449,625, filed on Jan. 24, 2017, and entitled “System and Method for Identifying and Assigning Professionals for a Particular Task,” the entire contents of which are hereby incorporated by reference in its entirety.

### FIELD OF THE INVENTION

The present disclosure is directed generally to a service for identifying and assigning professionals to perform a particular task, and more particularly to a verification process for matching attorneys with a project.

### BACKGROUND

In the legal field there are particular tasks that are sporadic and burdensome, requiring numerous attorneys to expend many working hours in a short time period. One example of such a task is document review, which usually takes place when there are large mergers, lawsuits, or other regulatory actions requiring each party to turn over thousands of documents for analysis by the opposing side. Law firms have found that hiring attorneys as full-time employees for sporadic document review is not economically beneficial. Therefore, law firms have started to rely on staffing agencies to find contract attorneys willing to work on a temporary basis during the document review.

However, law firms have found the process of hiring temporary contract attorneys through staffing agencies to be flawed. Online job postings by staffing agencies are often outdated and repeated. In some cases, staffing agencies post advertisements for jobs that do not exist in order to collect resumes to add to their database. Further, in order for applicants to respond to numerous job postings, they often must register with multiple different staffing agencies. In addition, the law firm seeking temporary contract attorneys must then wait for the staffing agency to collect resumes, review each candidate, verify the candidate's credentials, and act as a middleman of communication between the candidate and the law firm.

Therefore, there exists a need for an efficient staffing service which identifies professional candidates for a particular job and allows the law firm to quickly verify the candidate's qualifications and engage with the candidate directly.

### SUMMARY OF THE INVENTION

The present disclosure is directed to a system and method for identifying and assigning professionals to perform a particular task. In one embodiment, the system is computer processing system for identifying and assigning a professional to a particular task, comprising a computer processor having a non-transitory memory containing program code for first receiving user information from a candidate. The user information can include a candidate's contact information, bar admission status, education and work experience, for example. Next, the system verifies the user information and determines if the candidate has a conflict with the client for a particular task. Candidates with verified user information are entered into a qualified candidate pool and ranked based on skills and ratings from prior employers. An administrator for the particular task can review the user information of each qualified candidate. The administrator may select to submit a placement request to a qualified candidate. The qualified candidate has a specified time period within which he or she must either accept or reject the placement request. If the qualified candidate accepts the placement request, he or she is subject to a criminal conduct check. Upon passing the criminal check, the candidate is staffed for the task.

According to one aspect of the present disclosure is a method for submitting a placement request to at least one of a plurality of users by an administrator. The method includes the steps of: (i) providing a placement computer system, the computer system comprising a user interface configured to receive information about the plurality of users, a database configured to store the received information about the plurality of users, and a processor; (ii) receiving information via the user interface from each of the plurality of users, the information comprising identifying information about the user; (iii) automatically attempting to verify by the placement computer system, via communication between the placement computer system and one or more external databases, some or all of the identifying information about the user, and optionally requesting additional information about the user, wherein the additional information is based at least in part on the identifying information received from the user; (iv) entering the user into a candidate pool, if the placement computer system verifies a predetermined amount of the identifying information about the user, wherein the candidate pool is a list of one or more users and is stored in the database; (v) automatically ranking, by the processor, the candidate pool into a ranked list of users based on one or more predetermined parameters, wherein the parameters about the user are derived from the identifying information received from the user and/or from the requested additional information; and (vi) submitting, based at least in part on the ranked list of users, a placement request to at least one of said users.

According to an embodiment, the method further includes the steps of: reviewing, by the administrator via the user interface, the ranked list of users; and modifying, by the administrator, the ranking of the ranked list of users.

According to an embodiment, the placement request is based at least in part on the review by the administrator.

According to an embodiment, the identifying information or additional information comprises educational information about the user.

According to an embodiment, the identifying information or additional information comprises bar admission information about the user.

According to an embodiment, the identifying information or additional information comprises certification or licensure information about the user.

According to an embodiment, the additional information comprises a criminal history of the user.

According to an embodiment, the identifying information or additional information comprises language proficiency of the user.

According to an embodiment, the one or more predetermined parameters comprise a skill associated with the user.

According to an embodiment, the one or more predetermined parameters comprise a rating of the user.

According to an embodiment, the one or more predetermined parameters comprise a location of the user.

According to an aspect is a system for submitting a placement request to at least one of a plurality of users by an administrator. The system includes: a user interface configured to receive information from each of the plurality of users, the information comprising identifying information about the user; a database configured to store the received information about the plurality of users; and a processor configured to: (i) receive the information provided by each user via the user interface; (ii) automatically attempt to verify, via communication with one or more external databases, some or all of the identifying information about the user; (iii) enter the user into a candidate pool, if the placement computer system verifies a predetermined amount of the identifying information about the user, wherein the candidate pool is a list of one or more users and is stored in the database; (iv) automatically rank, by the processor, the candidate pool into a ranked list of users based on one or more predetermined parameters, wherein the parameters about the user are derived from the identifying information received from the user; and (v) submit, based at least in part on the ranked list of users, a placement request to at least one of said users.

According to an embodiment, the processor is further configured to request additional information about the user, wherein the additional information is based at least in part on the identifying information received from the user, and wherein the processor is further configured to automatically receive the requested additional information about the user.

According to an embodiment, the processor is configured to request the additional information about the user from one or more external databases.

According to an embodiment, the parameters about the user are derived in part from the additional information about the user.

According to an embodiment, the user interface is configured to: (i) present the ranked list of users to the administrator; and (ii) receive a modification of the ranked list of users from the administrator.

According to an embodiment, the processor is further configured to modify the ranked list based on the modification received from the administrator.

According to an embodiment, the placement request is based at least in part on the review by the administrator.

According to an embodiment, the identifying information or additional information comprises educational information about the user, bar admission information about the user, certification or licensure information about the user, a criminal history of the user, and/or language proficiency of the user.

According to an embodiment, the one or more predetermined parameters comprise a skill associated with the user, a rating of the user, and/or a location of the user.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely examples of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and, together with the description serve to explain the principles and operation of the invention.

### BRIEF DESCRIPTION OF THE DRAWINGS

The present invention will be more fully understood and appreciated by reading the following Detailed Description in conjunction with the accompanying drawings, in which:

FIG. 1 is a flowchart of a non-limiting illustrative embodiment of the reviewer onboarding process.

FIG. 2 is a flowchart of a non-limiting illustrative embodiment of the verification process.

FIG. 3 is a schematic representation of a non-limiting illustrative embodiment of the verification system.

### DETAILED DESCRIPTION OF EMBODIMENTS

Referring to the Figures, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

In use, the system provides a platform for a project or task administrator to identify professionals for the project or task based on qualifications, area of expertise and prior experience. The following description describes one representative embodiment of the invention wherein the administrator is an employee or member of a law firm and the professionals are contract attorneys and translators. However, the present invention is applicable to other fields, where the professionals are certified public accountants (CPAs), realtors, engineers, editors, or other similar workers required to have specialized skills or certifications.

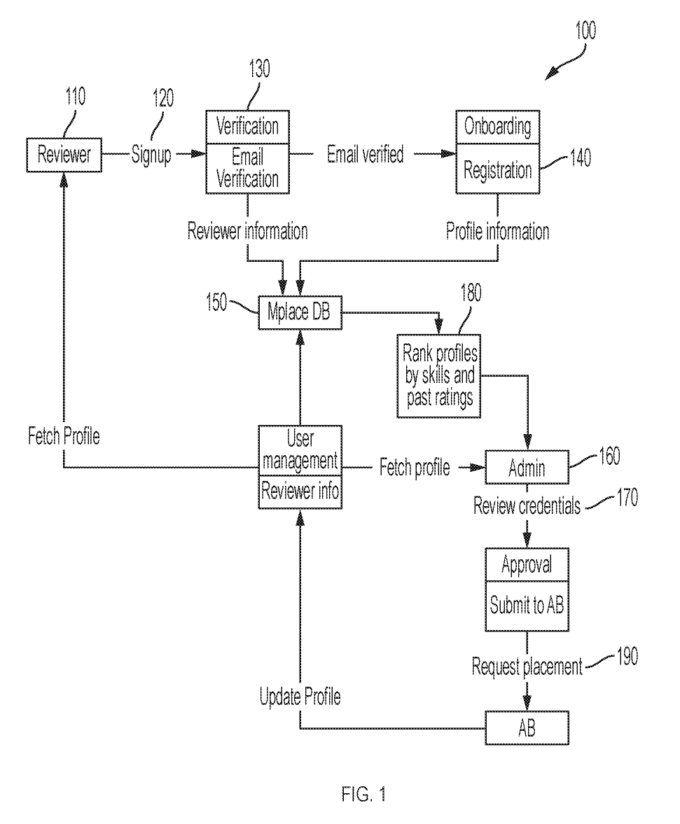

Referring to FIG. 1, in one embodiment, is a flowchart of a method 100 for an onboarding process for a contract attorney, hereinafter referred to as “user” or “reviewer” 110. Although described in relation to a contract attorney, it should be recognized that the process can be utilized for any similar position requiring a similar multi-step checking or certification process before or as part of hiring.

At step 120 of the method, the user registers for the service by entering user information, such as his or her name, email address, phone number, address, bar admissions, education, and prior work experience, for example. In alternative embodiments, the user information may also include other certifications, such as accounting licensure or a professional engineering license, for example. The user may be referred to the service by a link, email, or any other referral process, or the user may be directed to use the service at a physical location such as a prospective worksite or at a temp agency. The service may be accessed remotely through an online or other remote access point, or may be accessed via a terminal or other direct access point on a worksite location, or on a hiring location such as a temp agency.

At step 130 of the method, the user's email address is verified. One method for verifying the email address of the reviewer is to send a confirmation email to the provided email address. In some embodiments, the reviewer may upload documents relating to the above listed user information. For example, the reviewer may upload a resume, transcripts, a list of references, and/or one or more recommendations. There may be, for example, a portal, drop box, server, or other location where the user provides documents or other uploaded data for review or other use during the process.

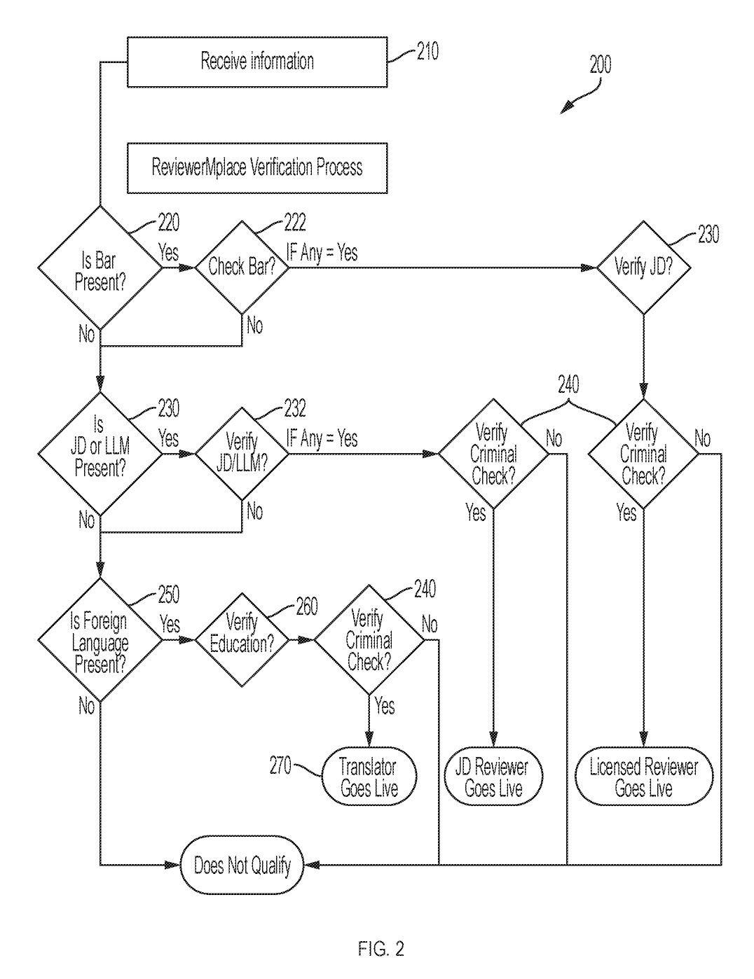

At step 130 of the method, pool of qualified candidates 150 is generated from the information provided by the user, and/or from one or more additional public and/or private information sources. Referring now to FIG. 2, according to one embodiment, is a flowchart of a method 200 for generated a pool of qualified candidates 150, including one or more verification steps. In this flowchart, the user's credentials and other information are reviewed and/or retrieved and analyzed as a component of the onboarding process. The verification process determines whether a reviewer can be considered for placement on a particular task.

At step 210 of the method, the system receives input comprising information about the user. The input may be received from the user directly, or may be provided by an intermediary such as a temp agency, or may be gathered automatically from one or more sources. For example, some information may be sought and retrieved automatically by the system using other provided information. As an example, publicly-available information such as addresses, dates of birth, bar admissions, certifications, and other information can be retrieved using a name provided by the user, with or without other information such as a social security number or other employment number. Accordingly, the system may be designed or programmed to seek out and gather this information automatically. This may be performed, for example, using free or paid access to one or more databases or other subscription-based information sources.

At step 220 of the method, the system determines whether bar admission information has been provided by the user. If it hasn't, or if the system is designed or configured to automatically confirm bar admission information, at step 222 the system seeks out and retrieves bar admission information from a publicly-available or privately-available source. The system may also check to determine whether the user has a specific bar admission, which may be necessary for the assignment(s) for which workers are being or will be sought.

At step 230 of the method, if the reviewer has a necessary bar admission, the system determines whether degree or other educational information has been provided by the user. If it hasn't, or if the system is designed or configured to automatically confirm degree or other educational information, at step 232 the system seeks out and retrieves degree information from a publicly-available or privately-available source. For example, the system may determine whether the user has received a Juris Doctor degree, and/or a Master of Laws degree (i.e., LLM), from one or more accredited institution. In the case of other advanced degrees such as Ph.D.s, the system may determine and/or verify whether the user has received the degree, and whether it was from an accredited institution. According to an embodiment, even if the reviewer is not admitted to a bar, the system can still verify that the reviewer has a Juris Doctor degree or an LLM.

At step 240 of the method, the system may perform a background check, searching for past criminal conduct by the user. If the reviewer does not pass the criminal conduct check, the user does not qualify for the position and is removed from consideration, or from the pool of candidates. As with any other check in the system, this check may require a rule set to determine which offenses are sufficient for removal from consideration, and which (such as a parking or speeding ticket) may not be sufficient for removal from consideration. Once again, the system may obtain this information from any publicly-available or privately-available source.

According to an embodiment, if the user passes the background check, such as the criminal conduct check, the user is verified as a qualifying reviewer at step 280 of the method. The user may automatically receive an offer, such as an engagement contract, or may be placed into a pool for additional review and verification.

At step 250 of the method, system may determine whether the reviewer has the ability to speak any or a specific foreign language. For example, according to one embodiment the system proceeds to this step if the reviewer is neither admitted to a bar nor has a Juris Doctor degree or a Master of Laws degree. Alternatively, the system may perform this check for every applicant. As just one example, if the reviewer does not have the ability to speak a required or desired foreign language, the reviewer may not qualify for any of the tasks.

However, if the reviewer can speak a foreign language, at step 260 of the method, the system verifies the education reported by the reviewer. The system may be designed to perform this verification for all applicants or users. The system may seek out and retrieve education information from a publicly-available or privately-available source.

According to one embodiment, at step 270 of the method, if the reviewer's education is verified, the reviewer may be deemed a “translator” and may be entered into a pool of candidates for tasks requiring a translator.

In alternative embodiments, the above described verification steps can be exchanged, moved, removed, supplemented, and/or replaced with alternative verification steps in which the credentials of the professional are verified. For example, the bar admission verification and Juris Doctor degree verification may be replaced with CPA licensure verification and accounting degree verification, respectively.

Continuing with a legal field embodiment, the reviewer may additionally be screened for a conflict with the task client. For example, the reviewer can be provided with a series of questions asking whether the reviewer has ever worked with or in opposition to a particular individual or business entity. The conflicts screening may also provide questions regarding particular assignments, cases, or projects. If the reviewer does not have a conflict, the reviewer may remain in or be directed to a pool of candidates for the particular task. If the reviewer has a conflict, the reviewer can be removed from the pool of candidates for the particular task, or flagged for additional review.

Referring again to FIG. 1, a pool of qualified candidates 150, such as the one generated by the process depicted in FIG. 2, is accessible to an administrator 160, who may be the individual or company creating a task to be staffed. In many scenarios in the legal field embodiment, the administrator is a hiring member of a law firm. As shown in FIG. 1, the administrator can review the profiles and credentials of reviewers in the pool of qualified candidates. Once the administrator has access to the pool of qualified candidates, the administrator can view the user information submitted by the reviewer. In some embodiments, this also includes access to documents uploaded by the reviewer. Accordingly, at step 170 of the method, the administrator 160 reviews one or more individuals in the pool of qualified candidates.

According to an embodiment, at step 180 of the method, the system can generate and/or present a ranked list of candidates, which can be stored and which may or may not be reviewed by the administrator 160. In the legal field embodiment, the system can rank reviewers in the pool of candidates based on the reviewer's skills and the reviewer's past ratings. In alternative embodiments, the ranking criteria may also include other factors such as proximity to the job site or psychological characteristics, for example. The administrator can adjust the ranked list before accepting it.

At step 190 of the method, the administrator can accept the ranked list, and/or a placement request can be transmitted to the first reviewer on the ranked list. However, if the task requires two reviewers, a placement request may be transmitted to the first two reviewers on the ranked list. Thus, the number of reviewers on the ranked list that receive placements requests depends on the number of reviewers required to complete the task. The placement request provides details regarding the task. The details may include the title of the position offered, the payment for the work, the location of the employer or the job site, and an approximation of the expected work hours or duration of the task. In one example relating to the legal field, the title of the position is “Reviewer;” the rate to be paid is $38.00 per hour; the location is Washington, D.C. 20004; and the expected work hours for the task are 41-60 hours per week. In one embodiment, the placement request additionally provides a rating of the administrator's law firm (or other business entity). The rating feature allows reviewers whom have previously worked for the administrator's law firm to provide feedback based on the working experience. In some embodiments, the placement request may also comprise a list of qualifications, which allows the reviewer to verify, again, that he or she meets the qualifications for the task.

At the next step, the reviewer receives the placement request. The reviewer may accept or reject the placement request. In one embodiment, the placement request has a time limitation. Thus, if the reviewer does not accept or reject the placement request within the time limitation, the placement request is rescinded and the reviewer can no longer act on the placement request. In some embodiments, not responding within the time limitation removes the reviewer from the candidate pool and ranked list for the particular task. It is contemplated that in one embodiment, if a reviewer does not respond to the placement request within the time limitation or the reviewer rejects the placement request, the system, by action of the processor, will transmit a placement request to the next available reviewer on the ranked list. This feature facilitates faster staffing of tasks and projects as the next available candidate receives a placement request as soon as the time limitation has elapsed or the first choice candidate rejects the placement request.

According to one embodiment, if the reviewer accepts the placement request, the system performs a background check, searching for past criminal conduct by the reviewer. Incorporating the criminal conduct check step after the reviewer has accepted the placement requests saves the administrator money and resources expended running the criminal conduct check by limiting it to committed candidates. If the reviewer does not pass the criminal conduct check, the placement request is rescinded and the reviewer is removed from the ranked list. In some embodiments, the system proceeds by sending a placement request to the next available reviewer on the ranked list.

If reviewer accepts the placement request and passes the background check, the reviewer may begin the task. All documents for the task are exchanged via the internet or other wired and/or wireless network. In some embodiments, the reviewer may access a time keeping feature in which the reviewer can record the time spent on the task. In addition, a messaging feature provides a direct pathway of communication between the administrator and the reviewer. The messaging feature allows the administrator to provide the reviewer with real-time updates, explanations or other information critical to the task.

Finally, the administrator may rate the work of the reviewer. The rating system may be any conventional system or combination or systems for reporting ratings, such as a numerical system and comment-based review. Permitting the administrator to rate the reviewer provides feedback to future administrators looking to staff tasks. The administrator can view the ratings of a particular reviewer and use the rating as an additional factor for determining whether to submit a placement request for that particular reviewer.

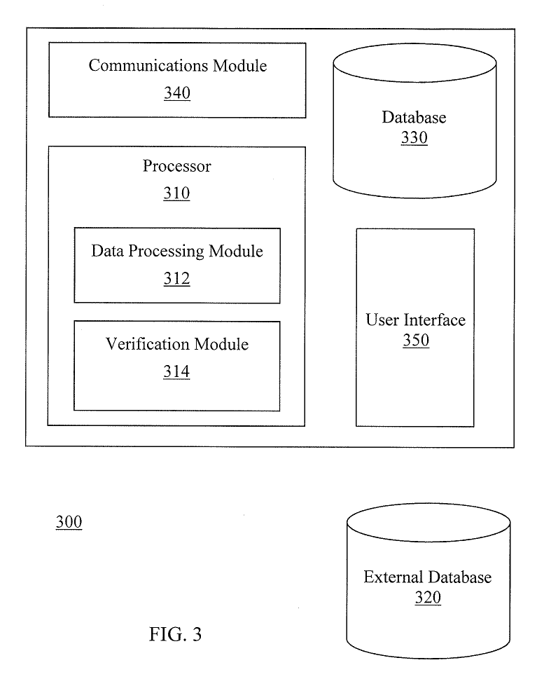

Referring to FIG. 3, in one embodiment, is a computer system 300 for identifying and assigning a professional to a particular task. According to an embodiment, computer system 300 comprises a processor 310 configured to receive, and/or store, and/or process information from or about one or more job candidates. Processor 310 may comprise, for example, a program or algorithm configured to comprise, perform, or otherwise execute any of the functionality described or otherwise envisioned herein. For example, processor 310 may comprise, for example, one or more programs or algorithms implemented as modules to execute any of the functionality described or otherwise envisioned herein.

According to an embodiment, processor 310 comprises a data processing module 312. Data processing module 312 can be configured to retrieve, receive, and/or store information about one or more users (or “job candidates,” or “professionals”). For example, data processing module 312 may receive information stored or to be stored in a database 330, and/or may receive information from a communications module 340. Data processing module 312 may also analyze and/or process the retrieved or received information prior to processing by the other modules. The information may be isolated, cleaned, or otherwise modified to improve one or more downstream functions, among many other types of data processing.

According to an embodiment, processor 310 comprises a verification module 314. Verification module 214 can be configured to perform one or more of the checks or verifications described or otherwise envisioned herein.

It is understood that one or more of the modules in computer system 300 can be stored in one or more remote memory storage devices or processors in a distributed configuration (not shown). According to an embodiment, one or more additional or alternative program modules may be used to implement functionality not specifically identified in FIG. 3.

According to an embodiment, computer system 300 comprises or is in communication with a database 330 which is configured to store the received information, other information utilized by the processor, and/or output from the processor. The computer system may also include a wired and/or wireless communications module 340, which can communicate via, for example, wired Wi-Fi, Bluetooth, cellular, IR, radio, or near field communication, among other communication methods. The communications module 340 can communicate with a network, another computer, a wired or wireless device, and/or any other device.

According to an embodiment, computer system 300 comprises a user interface 350. User interface 350 can present, for example, graphical, textual, and/or other visual information to the user. The user interface may also comprise one or more control features, such as a keyboard, computer mouse, and/or touchscreen, to allow the user to control the system. In one embodiment, the user interface 350 is a graphical user interface and may include a display screen or other type of display. According to an embodiment, the user and/or the administrator may utilize the user interface to input information to the system or receive information from the system. Accordingly, the system may comprise multiple user interfaces which are located with and/or remotely from the other components of system 300.

According to an embodiment, computer system 300 comprises, and/or is in communication with, one or more external databases 320, which may be queried or accessed via communications module 340, which can communicate via, for example, wired Wi-Fi, Bluetooth, cellular, IR, radio, or near field communication, among other communication methods. The one or more external databases 320 can be informational databases queried by the computer system for information about the user during one or more of the verification steps described or otherwise envisioned herein. For example, the external database may be a database of bar admissions, degree grantees, criminal convictions, and/or certification or licensing, among many other types of databases. In the case of a plurality of external databases, each external database may be located at a different location, and may be queried by the computer system independently, jointly, at certain times or intervals, or via any other pattern necessary to obtain the requested information about the user or another aspect of the system.

When implementing one or more of the methods as described herein, the functionality and speed of the computer system for hiring prospective users is significantly improved. Since much of the system is automated, including one or more of the verification checks, the system can query, obtain, and collate the data much faster than current systems requiring manual input, and this also saves time and resources of the system because it doesn't require human interaction at each stage. Indeed, many or most stages are completed without any direct human interaction. This isn't possible using current systems, which require human interaction to perform checks at multiple steps, which significantly slows down the computer system. Accordingly, the methods and systems described or otherwise envisioned herein significantly improve the functionality of the hiring process, and of a computer system tasked with implementing the hiring process.

While embodiments of the present invention has been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements.

What is claimed is:

1. A method for submitting a placement request to at least one of a plurality of users by an administrator, the method comprising the steps of:
providing a placement computer system, the computer system comprising a user interface configured to receive information about the plurality of users, a database configured to store the received information about the plurality of users, and a processor;
receiving information via the user interface from each of the plurality of users, the information comprising identifying information about the user;
automatically attempting to verify by the placement computer system, via communication between the placement computer system and one or more external databases, some or all of the identifying information about the user, and optionally requesting additional information about the user, wherein the additional information is based at least in part on the identifying information received from the user;
entering the user into a candidate pool, if the placement computer system verifies a predetermined amount of the identifying information about the user, wherein the candidate pool is a list of one or more users and is stored in the database;
automatically ranking, by the processor, the candidate pool into a ranked list of users based on one or more predetermined parameters, wherein the parameters about the user are derived from the identifying information received from the user and/or from the requested additional information; and
submitting, based at least in part on the ranked list of users, a placement request to at least one of said users.

2. The method of claim 1, further comprising the steps of:
reviewing, by the administrator via the user interface, the ranked list of users; and
modifying, by the administrator, the ranking of the ranked list of users.

3. The method of claim 3, wherein the placement request is based at least in part on the review by the administrator.

4. The method of claim 1, wherein the identifying information or additional information comprises educational information about the user.

5. The method of claim 1, wherein the identifying information or additional information comprises bar admission information about the user.

6. The method of claim 1, wherein the identifying information or additional information comprises certification or licensure information about the user.

7. The method of claim 1, wherein said additional information comprises a criminal history of the user.

8. The method of claim 1, wherein said identifying information or additional information comprises language proficiency of the user.

9. The method of claim 1, wherein the one or more predetermined parameters comprise a skill associated with the user.

10. The method of claim 1, wherein the one or more predetermined parameters comprise a rating of the user.

11. The method of claim 1, wherein the one or more predetermined parameters comprise a location of the user.

12. A system for submitting a placement request to at least one of a plurality of users by an administrator, the system comprising:
a user interface configured to receive information from each of the plurality of users, the information comprising identifying information about the user;
a database configured to store the received information about the plurality of users; and
a processor configured to: (i) receive the information provided by each user via the user interface; (ii) automatically attempt to verify, via communication with one or more external databases, some or all of the identifying information about the user; (iii) enter the user into a candidate pool, if the placement computer system verifies a predetermined amount of the identifying information about the user, wherein the candidate pool is a list of one or more users and is stored in the database; (iv) automatically rank, by the processor, the candidate pool into a ranked list of users based on one or more predetermined parameters, wherein the parameters about the user are derived from the identifying information received from the user; and (v) submit, based at least in part on the ranked list of users, a placement request to at least one of said users.

13. The system of claim 12, wherein the processor is further configured to request additional information about the user, wherein the additional information is based at least in part on the identifying information received from the user, and wherein the processor is further configured to automatically receive the requested additional information about the user.

14. The system of claim 13, wherein the processor is configured to request the additional information about the user from one or more external databases.

15. The system of claim 13, wherein the parameters about the user are derived in part from the additional information about the user.

16. The system of claim 12, wherein the user interface is configured to: (i) present the ranked list of users to the administrator; and (ii) receive a modification of the ranked list of users from the administrator.

17. The system of claim 16, wherein the processor is further configured to modify the ranked list based on the modification received from the administrator.

18. The system of claim 16, wherein the placement request is based at least in part on the review by the administrator.

19. The system of claim 12, wherein the identifying information or additional information comprises educational information about the user, bar admission information about the user, certification or licensure information about the user, a criminal history of the user, and/or language proficiency of the user.

20. The system of claim 12, wherein the one or more predetermined parameters comprise a skill associated with the user, a rating of the user, and/or a location of the user.
